(19) United States
(12) Patent Application Publication
(10) Pub. No.: US 2011/0242946 A1
(43) Pub. Date: Oct. 6, 2011

(54) Stepping motor control circuit and analog electronic timepiece

(76) Inventors: Kenji Ogasawara, Chiba-shi (JP); Akira Takakura, Chiba-shi (JP); Saburo Manaka, Chiba-shi (JP); Kazumi Sakumoto, Chiba-shi (JP); Keishi Honmura, Chiba-shi (JP); Hiroshi Shimizu, Chiba-shi (JP); Kosuke Yamamoto, Chiba-shi (JP); Shotaro Kamiyama, Chiba-shi (JP)

(21) Appl. No.: 13/066,043

(22) Filed: Apr. 5, 2011

(30) Foreign Application Priority Data
Apr. 6, 2010 (JP) 2010-087947
Feb. 1, 2011 (JP) 2011-020105

(51) Int. Cl. G04C 3/14; H02P 8/38

(52) U.S. Cl. 368/80; 318/696

(57) ABSTRACT

It is configured to include: a secondary battery as a power supply that supplies power at least to a stepping motor; a rotation detection portion that detects a rotation state of the stepping motor; a control portion that drives the stepping motor by selecting a drive pulse having energy corresponding to the rotation state of the stepping motor from a plurality of drive pulses; and a solar battery that charges the secondary battery. Upon determination that it is possible to rotate the stepping motor by an overcharge indicating drive pulse having predetermined energy, the control portion drives the stepping motor by changing a current drive pulse to an overconsuming drive pulse having larger energy than the overcharge indicating drive pulse. It thus becomes possible to suppress deterioration of a secondary battery caused by overcharge without having to provide a dedicated voltage detection circuit, such as a comparator circuit.

### BACKGROUND OF THE INVENTION

1. Field of the Invention

The present invention relates to a stepping motor control circuit and to an analog electronic timepiece using the stepping motor control circuit and a secondary battery as a power supply.

2. Background Art

A stepping motor has been used to drive hands and the like of an analog electronic timepiece.

Meanwhile, there has been developed an electronic timepiece using a secondary battery as a power supply that is charged by a power generator, such as a solar battery.

An electronic timepiece in the related art having a secondary battery as a power supply incorporates a voltage detection circuit, such as a comparator, to suppress overcharge of the secondary battery. As is described, for example, in JP-A-2008-256453, overcharge of the secondary battery is suppressed by activating a discharger, such as means for increasing energy of a motor drive pulse, when a voltage of the secondary battery exceeds a predetermined value.

It is possible to suppress overcharge of the secondary battery by controlling a voltage of the secondary battery as described above. This suppression technique, however, raises a problem that a dedicated voltage detection circuit, such as a comparator, used to detect a voltage of the secondary battery not only increases a circuit size and thereby makes a size reduction of the electronic timepiece difficult but also increases the cost thereof.

In addition, when the secondary battery is overdischarged in an environment where it is not automatically charged, there is a risk of a false operation or a breakdown of the electronic timepiece unless a state of the secondary battery being overdischarged is notified as quickly as possible.

### SUMMARY OF THE INVENTION

It is an aspect of the present application to allow a secondary battery coming out of a proper charge region to be detected without having to provide a dedicated voltage detection circuit, such as a comparator circuit.

It is another aspect of the present application to allow deterioration of a secondary battery caused by overcharge to be suppressed without having to provide a dedicated voltage detection circuit, such as a comparator circuit.

A stepping motor control circuit according to another aspect of the present application includes: a secondary battery as a power supply that supplies power at least to a stepping motor; a rotation detection portion that detects a rotation state of the stepping motor; and a control portion that drives the stepping motor by selecting a drive pulse having energy corresponding to the rotation state of the stepping motor from a plurality of drive pulses. Upon determination of a voltage of the secondary battery coming out of a proper charge region, the control portion performs a predetermined operation corresponding to the voltage of the secondary battery.

For example, a stepping motor control circuit includes: a secondary battery as a power supply that supplies power at least to a stepping motor; a rotation detection portion that, detects a rotation state of the stepping motor; and a control portion that drives the stepping motor by selecting a drive pulse having energy corresponding to the rotation state of the stepping motor from a plurality of drive pulses. Upon determination that it is possible to rotate the stepping motor by an overcharge indicating drive pulse having predetermined energy, the control portion drives the stepping motor by changing a current drive pulse to an overconsuming drive pulse having larger energy than the overcharge indicating drive pulse.

Also, an analog electronic timepiece according to another aspect of the present application includes a stepping motor that rotationally drives hands of a timepiece and a control portion that controls the stepping motor. The control portion that controls the stepping motor is formed of the stepping motor control circuit described above.

According to the stepping motor control circuit of the present application, it becomes possible to detect the secondary battery coming out of the proper charge region without having to provide a dedicated voltage detection circuit, such as a comparator circuit.

Also, according to the stepping motor control circuit of the present application, it becomes possible to suppress deterioration of the secondary battery caused by overcharge without having to provide a dedicated voltage detection circuit, such as a comparator circuit.

Further, according to the analog electronic timepiece of the present application, because it becomes possible to suppress deterioration of the secondary battery caused by overcharge without having to provide a dedicated voltage detection circuit, such as a comparator circuit, a size reduction can be achieved.

### BRIEF DESCRIPTION OF THE DRAWINGS

FIG. 1 is a block diagram of an analog electronic timepiece according to an embodiment of the invention;

FIG. 2 is a flowchart of a stepping motor control circuit and an analog electronic timepiece according to a first embodiment of the invention;

FIG. 3 is a flowchart of a stepping motor control circuit and an analog electronic timepiece according to a second embodiment of the invention;

FIG. 4 is a flowchart of a stepping motor control circuit and an analog electronic timepiece according to a third embodiment of the invention; and

FIG. 5 is a flowchart of a stepping motor control circuit and an analog electronic timepiece according to a fourth embodiment of the invention.

### DESCRIPTION OF THE PREFERRED EMBODIMENTS

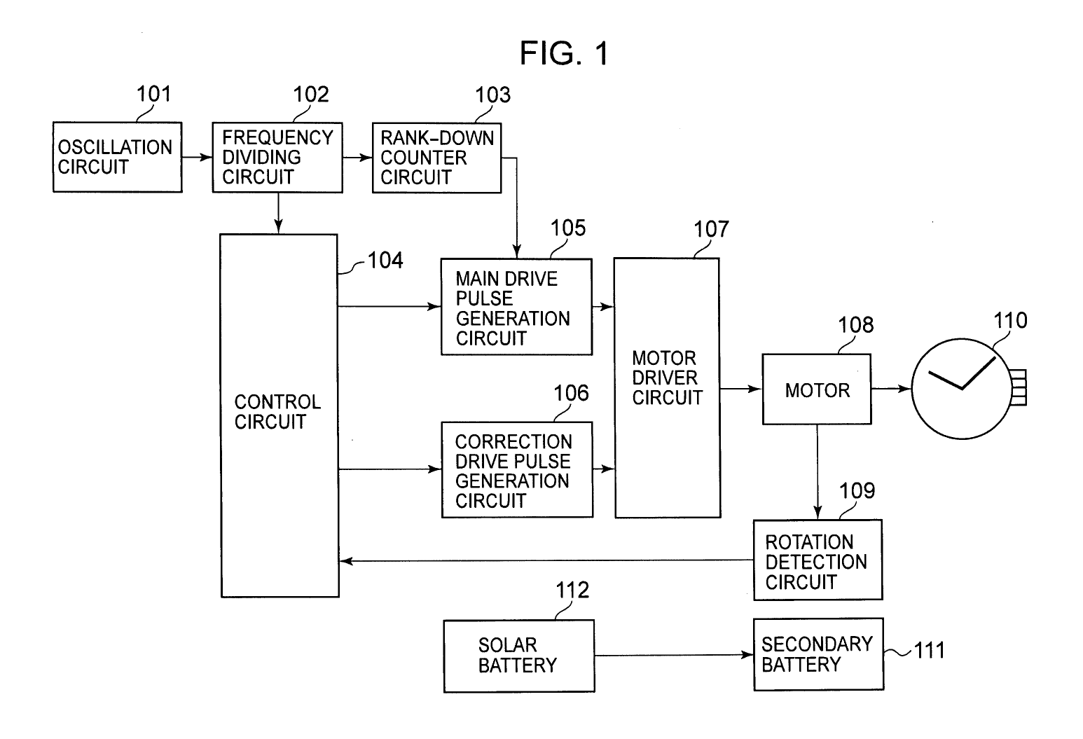

FIG. 1 is a block diagram of an analog electronic timepiece using a stepping motor control circuit according to an embodiment of the invention. This block diagram is common in all embodiments described below and shows an example of the case where the analog electronic timepiece is an analog electronic watch.

Referring to FIG. 1, the analog electronic timepiece includes an oscillation circuit 101 that generates a signal at a predetermined frequency, a frequency dividing circuit 102 that generates timepiece signal as a timing reference by dividing a signal generated at the oscillation circuit 101, a control circuit 104 that controls a timer operation of the timepiece signal and respective electronic circuit elements forming the analog electronic timepiece or performs various types of control, such as control on changing of drive pulses, and a rank-down counter circuit 103 that outputs to a main drive pulse generation circuit 105 a rank-down signal ranking down a main drive pulse P1 each time it counts timepiece signals over a predetermined time.

The analog electronic timepiece also includes the main drive pulse generation circuit 105 that selectively outputs one of a plurality of main drive pulses P1 each having different energy according to a main drive pulse control signal from the control circuit 104 and lowers the rank of the main drive pulse P1 by one grade (ranks down) in response to the rank-down signal, a correction drive pulse generation circuit 106 that outputs a correction drive pulse P2 having larger energy than the respective main drive pulses P1 according to a correction drive pulse control signal from the control circuit 104, and a motor driver circuit 107 that rotationally drives a stepping motor 108 in response to the main drive pulse P1 from the main drive pulse generation circuit 105 and the correction drive pulse P2 from the correction drive pulse generation circuit 106.

Further, the analog electronic timepiece includes the stepping motor 108 that is rotationally driven by the motor driver circuit 107, an analog display portion 110 having hands of a timepiece for displaying a time and a calendar display portion and the like that are rotationally driven by the stepping motor 108, a rotation detection circuit 109 that detects an induced signal VRs generated by the stepping motor 108 in a predetermined rotation detection section and outputs a detection signal indicating a rotation state, a secondary battery 111 as a power supply that supplies power to respective electronic circuit elements of the analog electronic timepiece including the stepping motor 108, and a solar battery 112 that charges the secondary battery 111.

The rotation detection section within which to detect whether the stepping motor 108 is rotating is set immediately after the rotationally driving by the main drive pulse P1. The rotation detection circuit 109 detects a rotation state indicating whether the stepping motor 108 is rotating normally (that is, whether drive energy of the main drive pulse P1 is sufficient or insufficient) by determining whether the induced signal VRs generated by free oscillations immediately after the driving of the stepping motor 108 exceeds a predetermined reference threshold voltage Vcomp.

The control circuit 104 determines the rotation state of the stepping motor 108 on the basis of a detection signal from the rotation detection circuit 109 and outputs a control signal to the main drive pulse generation circuit 105 or the correction drive pulse generation circuit 106 to perform pulse control, such as raking-up or ranking down of the main drive pulse P1 and drive control by the correction drive pulse P2. A plurality of drive pulses each having different energy (each having a different pulse width) as the main drive pulses P1 and the correction drive pulse P2 having larger energy than the respective main drive pulses P1 (that is, having a wider pulse width) and capable of forcedly rotating the stepping motor 108 are prepared as drive pulses.

A drive pulse P1min having minimum energy among the main drive pulses P1 is a main drive pulse (overcharge indicating drive pulse Pkj) indicating that the secondary battery 111 is overcharged (that is, the secondary battery 111 is in a state where it is charged to or above a predetermined voltage (for example, a maximum rated charging voltage specified so as not to shorten the life of the secondary battery 111) and out of a proper charge region).

A pulse width of the overcharge indicating drive pulse Pkj is set as follows. That is, when the secondary battery 111 is not overcharged and has a voltage not greater than the predetermined voltage, the overcharge indicating drive pulse Pkj is incapable of rotating the stepping motor 108 because energy thereof is small, whereas when the secondary battery 111 is overcharged and has a voltage exceeding the predetermined voltage, the overcharge indicating drive pulse Pkj is capable of rotating the stepping motor 108 regardless of a narrow pulse width because energy thereof increases.

Upon determination of ranking down to the overcharge indicating drive pulse Pkj having predetermined energy, the control circuit 104 determines that the secondary battery 111 is in an overcharge region, which is out of the proper charge region, and performs predetermined control.

A drive pulse P1max having maximum energy among the main drive pulses P1 is a main drive pulse (overdischarge indicating drive pulse Pkh) indicating that the secondary battery 111 is overdischarged (for example, the secondary battery 111 is in a state where it is charged to or below a predetermined voltage (for example, a least necessary rated voltage to drive the analog electronic timepiece) and out of the proper charge region). A pulse width of the overdischarge indicating drive pulse Pkh is set as follows. That is, when the secondary battery 111 is not overdischarged and has a voltage not less than the predetermined voltage, the overdischarge indicating drive pulse Pkh is capable of rotating the stepping motor 108 because energy thereof is large, whereas when the secondary battery 111 is overdischarged and has a lower voltage, the overdischarge indicating drive pulse Pkh is incapable of rotating the stepping motor 108 regardless of a wide pulse width because energy thereof becomes small.

Upon determination of ranking up to the overdischarge indicating drive pulse Pkh having predetermined energy, the control circuit 104 determines that the secondary battery 111 is in an overdischarge region, which is out of the proper charge region, and performs predetermined control.

For example, the predetermined voltage in the proper charge region of the secondary battery 111 is set to 1.2 V to 2.0 V, which is a rated charging voltage specified for the secondary battery 111. In this case, the overcharge indicating drive pulse Pkj is set to indicate that the secondary battery 111 is charged to 2.0 V or above, which is an overcharge region out of the proper charge region, whereas the overdischarge indicating drive pulse Pkh is set to indicate that a voltage of the secondary battery 111 has dropped to 1.2 V or below, which is an overdischarge region out of the proper charge region.

The secondary battery 111 is formed to supply power not only to the stepping motor 108 but also to all the circuit elements of the analog electronic timepiece. However, the secondary battery 111 may be formed to supply power at least to the stepping motor 108.

Herein, the oscillation circuit 101 and the frequency dividing circuit 102 form a signal generation portion. The analog display portion 110 forms a display portion and the rotation detection circuit 109 forms a rotation detection portion. The solar battery 112 includes a power generator that generates power and a charger that charges the secondary battery 111. The main drive pulse generation circuit 105 and the correction drive pulse generation circuit 106 form a drive pulse generation portion. The oscillation circuit 101, the frequency dividing circuit 102, the rank-down counter circuit 103, the control circuit 104, the main drive pulse generation circuit 105, the correction drive pulse generation circuit 106, and the motor driver circuit 107 form a control portion.

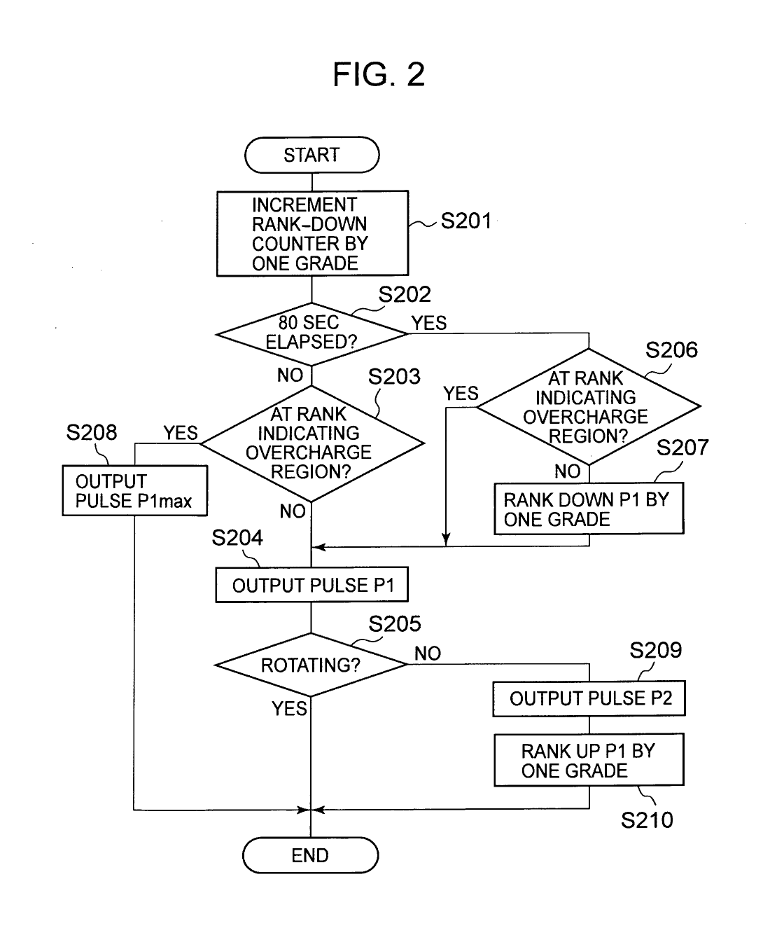

FIG. 2 is a flowchart depicting an operation in the first embodiment of the invention.

Hereinafter, an operation in the first embodiment of the invention will be described in detail with reference to FIG. 1 and FIG. 2.

The solar battery 112 generates power and charges the secondary battery 111 under the control of the control circuit 104. The analog electronic timepiece operates as power is supplied to the circuit elements of the analog electronic timepiece including the stepping motor 108 from the secondary battery 111 as a power supply.

Firstly, the general outline of a normal time display operation will be described. Referring to FIG. 1, the oscillation circuit 101 generates a signal at a predetermined frequency. The frequency dividing circuit 102 generates a timepiece signal (for example, a signal having a cycle of one second) as a timing reference by dividing the signal generated at the oscillation circuit 101 and outputs the timepiece signal to the rank-down counter circuit 103 and the control circuit 104.

The control circuit 104 outputs a main drive pulse control signal to the main drive pulse generation circuit 105 so that the stepping motor 108 is rotationally driven in a predetermined cycle in response to the timepiece signal.

The main drive pulse generation circuit 105 outputs to the motor driver circuit 107 a main drive pulse P1 at an energy rank corresponding to the main drive pulse control signal from the control circuit 104. The motor driver circuit 107 then rotationally drives the stepping motor 108 with the main drive pulse P1. The stepping motor 108 is therefore rotationally driven by the main drive pulse P1 and in turn rotationally drives the hands of a timepiece in the analog display portion 110. Accordingly, while the stepping motor 108 is rotating normally, a current time, etc. is displayed by the hands of a timepiece in the analog display portion 110.

The rank-down counter circuit 103 performs a timer operation by counting timepiece signals from the frequency dividing circuit 102 and outputs a rank-down signal ranking down the main drive pulse P1 to the main drive pulse generation circuit 105 in a predetermined cycle (for example, a cycle of 80 seconds).

In response to the rank-down signal, the main drive pulse generation circuit 105 changes the current main drive pulse P1 to a main drive pulse P1 at an energy rank lowered by one grade and outputs the changed main drive pulse P1 to the motor driver circuit 107. The motor driver circuit 107 drives the stepping motor 108 with the main drive pulse P1 ranked down by one grade.

The rotation detection circuit 109 detects a rotation state of the stepping motor 108 by detecting an induced signal VRs generated by free oscillations of the stepping motor 108 in the rotation detection section immediately after a completion of the driving of the stepping motor 108 by the main drive pulse P1. When the induced signal VRs exceeds the predetermined reference threshold voltage Vcomp, the rotation detection circuit 109 outputs a first detection signal indicating that the stepping motor 108 is rotating (in other words, energy of the main drive pulse P1 is sufficient). When the induced signal VRs does not exceed the reference threshold voltage Vcomp, the rotation detection circuit 109 outputs a second detection signal indicating that the stepping motor 108 is not rotating (in other words, energy of the main drive pulse P1 is insufficient).

When the rotation detection circuit 109 detects that the stepping motor 108 is not rotating, that is, upon receipt of the second detection signal from the rotation detection circuit 109, the control circuit 104 outputs a correction drive pulse control signal to the correction drive pulse generation circuit 106. In response to the correction drive pulse control signal, the correction drive pulse generation circuit 106 forcedly rotates the stepping motor 108 with the correction drive pulse P2 via the motor driver 107.

Also, when the control circuit 104 receives the second detection signal, the control circuit 104 performs control so that the main drive pulse P1 is ranked up by one grade in the following driving by outputting a main drive pulse control signal to the main drive pulse generation circuit 105 in the following driving.

In the following driving, the main drive pulse generation circuit 105 drives the stepping motor 108 with the main drive pulse P1 having energy ranked up by one grade in response to the control signal. Accordingly, the stepping motor 108 is driven by the main drive pulse P1 having one-rank higher energy.

An operation including a power overconsuming operation when the secondary battery 111 is overcharged will now be described along FIG. 2.

When the rank-down counter circuit 103 counts one timepiece signal from the frequency dividing circuit 102 (Step S201), the control circuit 104 determines whether a predetermined time (80 seconds in this embodiment) has elapsed, that is, whether the rank-down counter circuit 103 has measured 80 seconds as the predetermined time (Step S202).

Upon determination that the predetermined time has not elapsed in Step S202, in a case where the main drive pulse P1 used in the current driving is not a drive pulse (the overcharge indicating drive pulse Pkj, which is a main drive pulse P1 having energy ranked at the bottom) at an energy rank indicating that a voltage of the secondary battery 111 is in the overcharge region (Step S203), the control portion 104 outputs a main drive pulse control signal to the main drive pulse generation circuit 105 so that stepping motor 108 is rotationally driven by the current main drive pulse P1 (Step S204). In response to the main drive pulse control signal, the main drive pulse generation circuit 105 rotationally drives the stepping motor 108 with the current main drive pulse P1 via the motor driver circuit 107.

The rotation detection circuit 109 detects a rotation state of the stepping motor 108 with the driving by the main drive pulse P1 and outputs a corresponding detection signal to the control circuit 104. Upon determination that the stepping motor 108 is rotating on the basis of the detection signal, the control circuit 104 ends the processing (Step S205). The control circuit 104 performs control so that the stepping motor 108 is rotationally driven by the current main drive pulse P1 in the following driving.

Upon determination that the stepping motor 108 is not rotating on the basis of the detection signal (Step S205), the control circuit 104 outputs a correction drive pulse control signal to the correction drive pulse generation circuit 106 so that the stepping motor 108 is rotationally driven by the correction drive pulse P2 (Step S209). The control circuit 104 then ranks up the main drive pulse P1 by one grade and ends the processing (Step S210). In response to the correction drive pulse control signal, the correction drive pulse generation circuit 106 forcedly drives the stepping motor 108 to rotate with the correction drive pulse P2 via the motor driver circuit 107. Accordingly, the stepping motor 108 rotates. In the following driving, the stepping motor 108 is driven by a main drive pulse P1 at one rank higher than the current main drive pulse P1.

In a case where it is found in Step S203 that the main drive pulse P1 used in the current driving is the overcharge indicating drive pulse Pkj, the control circuit 104 outputs a main drive pulse control signal to the main drive pulse generation circuit 105 so that the stepping motor 108 is rotationally driven by the overconsuming drive pulse Pks (in the first embodiment, the main drive pulse P1max, which is a main drive pulse P1 having maximum energy) having predetermined energy larger than the energy of the overcharge indicating drive pulse Pkj (Step S208).

In response to the main drive pulse control signal, the main drive pulse generation circuit 105 rotationally drives the stepping motor 108 with the overconsuming drive pulse Pks having predetermined energy larger than the energy of the overcharge indicating drive pulse Pkj via the motor driver circuit 107. Accordingly, because large energy is consumed, it becomes possible to bring the secondary battery 111 from the overcharge region to the proper charge region by quickly reducing a charged amount thereof.

After the control to rotationally drive the stepping motor 108 with the overconsuming drive pulse Pks in Step S208, the control circuit 104 ends the processing while maintaining a condition under which the stepping motor 108 is driven by the overcharge indicating drive pulse Pkj in the following driving. In a case where the control circuit 104 proceeds to the processing in Step S203 in the following driving, because the control circuit 104 maintains the condition under which the stepping motor 108 is driven by the overcharge indicating drive pulse Pkj from the last processing, the control circuit 104 determines in Step S203 in the current driving that the main drive pulse P1 used in the current driving is the overcharge indicating drive pulse Pkj. Hence, as in the last time, the control circuit 104 performs control so that the stepping motor 108 is rotationally driven by the overconsuming drive pulse Pks. Thereafter, the control circuit 104 repeats the processing described above.

Upon determination that the predetermined time has elapsed in Step S202, in a case where a main drive pulse P1 used in the current driving is a drive pulse (overcharge indicating drive pulse Pkj) at an energy rank indicating that it is in the overcharge region, the control circuit 104 proceeds to Step S204 and outputs a control signal to the main drive pulse generation circuit 105 so that the stepping motor 108 is driven by the overcharge indicating drive pulse Pkj (Step S206).

In this case, the stepping motor 108 is rotationally driven by the overcharge indicating drive pulse Pkj (Step S204) and driving by the correction drive pulse P2 and ranking up are performed depending on the rotation state (Steps S205, S209, and S210). Accordingly, in a case where the main drive pulse becomes the overcharge indicating drive pulse Pkj, the driving is performed by the overconsuming drive pulse Pks until the predetermined time (80 seconds in the first embodiment) has elapsed (Steps S202, S203, and S208), and the driving by the overcharge indicating drive pulse Pkj is performed when the predetermined time has elapsed (Steps S202, S206, and S204).

In a case where it is found in Step S206 that the main drive pulse P1 used in the current driving is not the overcharge indicating drive pulse Pkj, the control circuit 104 ranks down the main drive pulse P1 by one grade (Step S207) and proceeds to Step S204.

Upon determination that the stepping motor 108 is not rotating (Step S205), the control circuit 104 outputs a correction drive pulse control signal to the correction drive pulse generation circuit 106 so that the stepping motor 108 is rotationally driven by the correction drive pulse P2 (Step S209). The control circuit 104 then ranks up the main drive pulse P1 by one grade and ends the processing (Step S210). Accordingly, in the following driving, the stepping motor 108 is driven by a main drive pulse P1 one rank higher than the current main drive pulse P1. In a case where the overcharge indicating drive pulse Pkj is used in the current driving, the stepping motor 108 is driven by a main drive pulse P1 one rank higher than the overcharge indicating drive pulse Pkj in the following driving.

Hence, driving by the overcharge indicating drive pulse Pkj is performed each time the stepping motor 108 is driven for a predetermined time (in other words, a predetermined number of times) by the overconsuming drive pulse Pks. In a case where the stepping motor 108 is not rotated by the overcharge indicating drive pulse Pkj, the main drive pulse P1 is ranked up to change the current main drive pulse P1 to another main drive pulse P1 other than the overconsuming drive pulse Pkj and the stepping motor 108 is driven by the changed main drive pulse P1.

As has been described, according to the first embodiment, it is configured to include the secondary battery 111 as a power supply that supplies power at least to the stepping motor 108, the rotation detection circuit 109 that detects a rotation state of the stepping motor 108, and the control portion that drives the stepping motor 108 by selecting a drive pulse having energy corresponding to the rotation state of the stepping motor 108 from a plurality of drive pulses. Upon determination of a voltage of the secondary battery 111 coming out of the proper charge region, the control portion performs a predetermined operation corresponding to the voltage of the secondary battery 111.

Also, according to the first embodiment, it is configured to include the secondary battery 111 as a power supply that supplies power at least to the stepping motor 108, the rotation detection circuit 109 that detects a rotation state of the stepping motor 108, the control portion that drives the stepping motor 108 by selecting drive pulses P1 and P2 having energy corresponding to the rotation state of the stepping motor 108 from a plurality of drive pulses P1 and P2, and the charger that charges the secondary battery 111. Upon determination that it is possible to rotate the stepping motor 108 by the overcharge indicating drive pulse Pkj having predetermined energy among a plurality of the drive pulses P1 and P2, the control portion drives the stepping motor 108 by changing a current drive pulse to the overconsuming drive pulse Pks having predetermined energy larger than energy of the overcharge indicating drive pulse Pkj.

Accordingly, it becomes possible to detect the secondary battery 111 coming out of the proper charge region without having to provide a dedicated voltage detection circuit, such as a comparator circuit, and an operation corresponding to the detection result is enabled.

Also, the secondary battery 111 is determined as being overcharged in a case where it is possible to drive the stepping motor 108 by the overcharge indicating drive pulse Pkj and energy is consumed exceedingly by driving the stepping motor 108 by a drive pulse having energy larger than the energy necessary to rotate the stepping motor 108, so that overcharge is eliminated by quickly reducing a charged amount of the secondary battery 111. It thus becomes possible to suppress deterioration of the secondary battery 111 by suppressing overcharge of the secondary battery 111 without having to provide a dedicated voltage detection circuit, such as a comparator circuit.

By using the overcharge indicating drive pulse Pkj and the overconsuming drive pulse Pks as a drive pulse with which to normally drive the stepping motor 108, there can be achieved an advantage that the types of drive pulse does not have to be increased. However, an overcharge indicating drive pulse Pkj exclusively used for overcharge determination and an overconsuming drive pulse Pks exclusively used for overconsumption may be adopted as well.

Also, it becomes possible to consume large power while rotating the stepping motor 108 by the overconsuming drive pulse Pks.

In addition, according to the first embodiment, because it becomes possible to suppress overcharge of the secondary battery 111 without having to provide a dedicated voltage detection circuit, such as a comparator, the circuit configuration can be smaller. A compact analog electronic timepiece can be thus fabricated.

Further, it is configured in such a manner that the drive pulse is returned to the overcharge indicating drive pulse Pkj at certain time intervals and when it is determined that the stepping motor 108 does not rotate when driven by the overcharge indicating drive pulse Pkj, it is determined as not being in the overcharge region. It is therefore possible to determine whether the secondary battery 111 is in the overcharge region with accuracy.

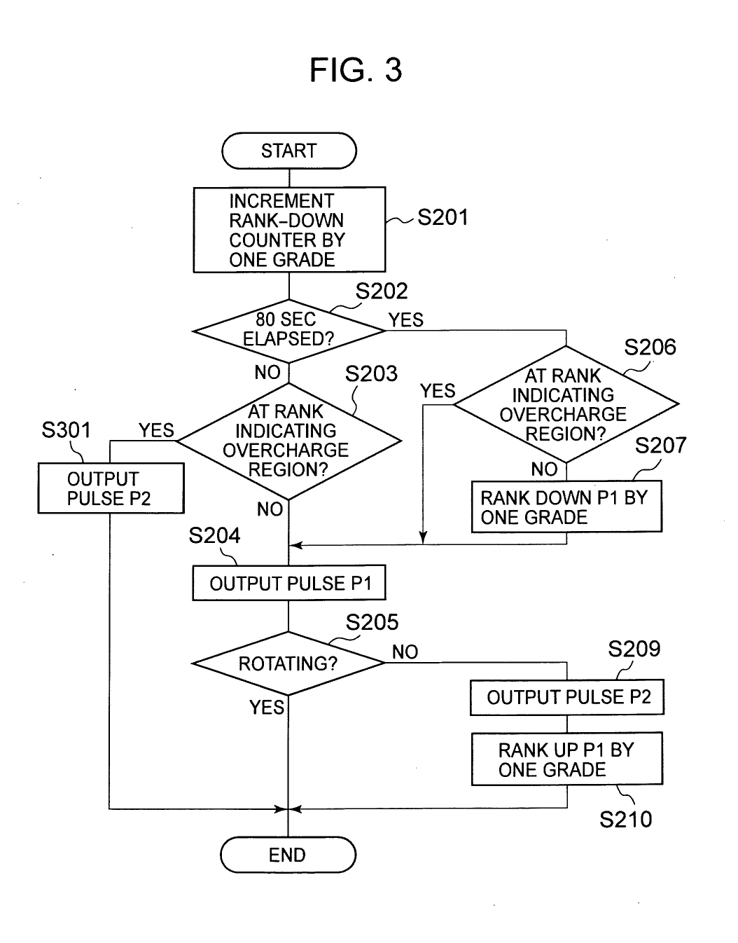

FIG. 3 is a flowchart depicting an operation in a second embodiment of the invention. A block diagram of the second embodiment is the same as that of FIG. 1.

In the first embodiment above, it is configured in such a manner that the secondary battery 111 is determined as being overcharged in a case where it is possible to rotate the stepping motor 108 by the overcharge indicating drive pulse Pkj and overcharge is eliminated by driving the stepping motor 108 by the main drive pulse P1max having maximum energy, which is the overconsuming drive pulse Pks. On the contrary, in the second embodiment, it is configured in such a manner that in a case where the secondary battery 111 is determined as being overcharged, the stepping motor 108 is driven by using the correction drive pulse P2 as the overconsuming drive pulse Pks.

More specifically, in a case where it is found in Step S203 of FIG. 3 that the main drive pulse P1 used in the current driving is the overcharge indicating drive pulse Pkj, the control circuit 104 outputs a correction drive pulse control signal to the correction drive pulse generation circuit 106 so that the stepping motor 108 is rotationally driven by the overconsuming drive pulse Pks (the correction drive pulse P2 in the second embodiment) having predetermined energy larger than the energy of the overcharge indicating drive pulse Pkj (Step S301).

In response to the correction drive pulse control signal, the correction drive pulse generation circuit 106 rotationally drives the stepping motor 108 with the overconsuming drive pulse Pks (the correction drive pulse P2 in the second embodiment) having predetermined energy larger than the energy of the overcharge indicating drive pulse Pkj via the motor driver circuit 107. Accordingly, because large energy is consumed, it becomes possible to bring the secondary battery 111 from the overcharge region to the proper charge region by quickly reducing a charged amount thereof. In addition, because the overconsuming drive pulse Pks having larger energy than in the first embodiment above is used, an overcharge suppressing advantage is more significant.

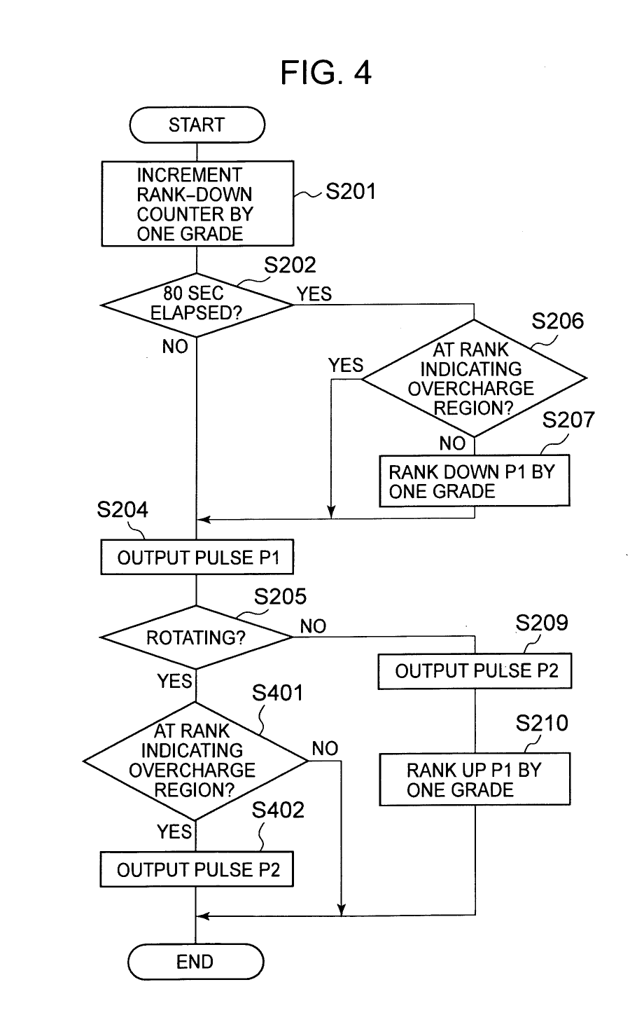

FIG. 4 is a flowchart depicting an operation in a third embodiment of the invention. A block diagram of the third embodiment is the same as that of FIG. 1.

In the first and second embodiments above, it is configured in such a manner as described above that in a case where the secondary battery 111 is determined as being overcharged, the stepping motor 108 is driven by using a single main drive pulse P1max or correction drive pulse P2 as the overconsuming drive pulse Pks. On the contrary, in this embodiment, it is configured in such a manner that overcharge is suppressed by consuming large power by driving the stepping motor 108 by a set of a plurality of drive pulses.

More specifically, in a case where the stepping motor 108 is rotating when driven by the main drive pulse P1 in Step S204 of FIG. 4 and the main drive pulse P1 used in this instance is the overcharge indicating drive pulse Pkj, the control circuit 104 drives the stepping motor 108 by the correction drive pulse P2 of the same polarity (Steps S205, S401, and S402). In this manner, in a case where the main drive pulse P1 is the overcharge indicating drive pulse Pkj indicating overcharge, the stepping motor 108 is driven also by the correction drive pulse P2 in addition to the driving by the overcharge indicating drive pulse Pkj (Step S204 and S402).

As has been described, because it is configured in such a manner that the overconsuming drive pulse Pks is formed of a set of a plurality of drive pulses (the overcharge indicating drive pulse Pkj and the correction drive pulse P2 in the third embodiment), as with the first and second embodiments above, large energy is consumed. It thus becomes possible to bring the secondary battery 111 from the overcharge region to the proper charge region by quickly reducing a charged amount thereof. Also, it is configured in such a manner that the stepping motor 108 is rotated by the overcharge indicating drive pulse Pkj used first for the driving and merely large power is consumed without rotating the stepping motor 108 by the following correction drive pulse P2 of the same polarity. Hence, responsibilities of the respective drive pulses can be divided clearly, which facilitates the control.

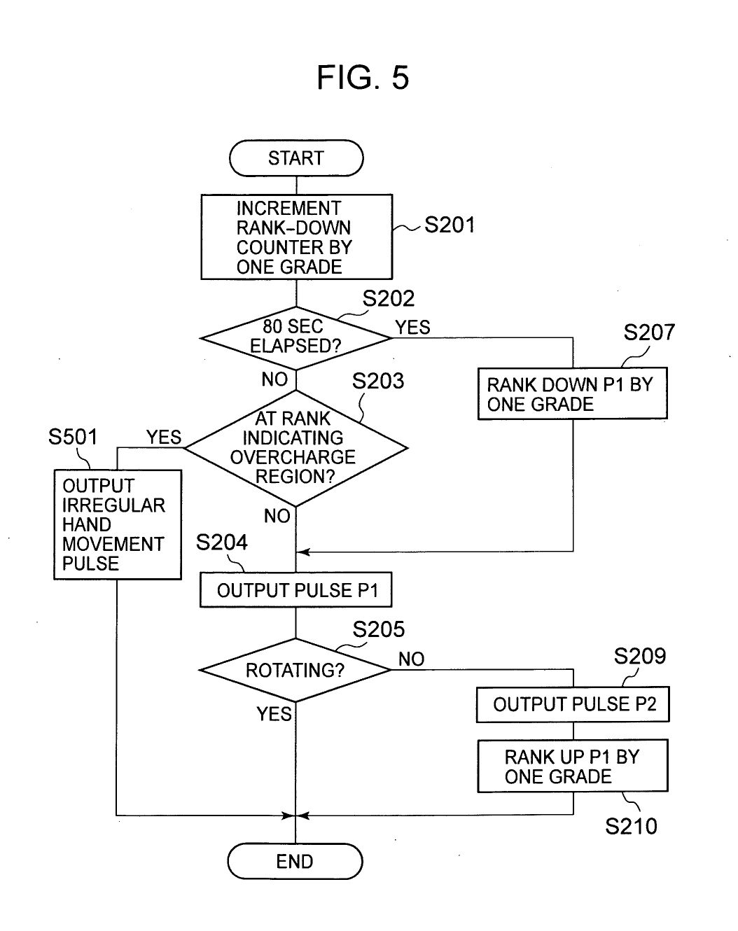

FIG. 5 is a flowchart depicting an operation in a fourth embodiment of the invention. Steps in which the same processing is performed are labeled with the same step numbers with respect to FIG. 2 through FIG. 4. A block diagram of the fourth embodiment is the same as that of FIG. 1.

The first through third embodiments have described a case where the secondary battery 111 goes into the overcharge region. On the contrary, the fourth embodiment will describe a case where the secondary battery 111 goes into an overdischarge region. It should be appreciated that the fourth embodiment can be combined with each of the first through third embodiments above.

Referring to FIG. 1 and FIG. 5, upon determination that the predetermined time has not elapsed in Step S202, in a case where the main drive pulse P1 used in the current driving is not a drive pulse (the overdischarge indicating drive pulse Pkh (the main drive pulse P1max having energy ranked at the top in the fourth embodiment)) indicating that a voltage of the secondary battery 111 is in the overdischarge region (Step S203), the control circuit 104 outputs a main drive pulse control signal to the main drive pulse generation circuit 105 so that the stepping motor 108 is rotationally driven by the current main drive pulse P1 (Step S204). In response to the main drive pulse control signal, the main drive pulse generation circuit 105 rotationally drives the stepping motor 108 by the current main drive pulse P1 via the motor driver circuit 107.

Upon determination that the main drive pulse P1 used in the current driving is the overdischarge indicating drive pulse Pkh having predetermined energy in Step S203, the control circuit 104 determines that the secondary battery 111 is in the overdischarge region. The control circuit 104 then performs control so that the stepping motor 108 is rotationally driven by the main drive pulse P1max at the highest energy rank for the hands of a timepiece to undergo an irregular hand movement (driving of the stepping motor 108 in this case is referred to as the irregular driving) different from a regular hand movement (driving of the stepping motor 108 in this case is referred to as the regular driving) (Step S501).

A drive pulse used in Step S501 is a drive pulse as large as or larger than the overdischarge indicating drive pulse Pkh in order to rotate the stepping motor 108 in a more reliable manner. It is, however, possible to use the main drive pulse P1max having maximum energy, the correction drive pulse P2, or a particular drive pulse as long as it is a drive pulse as large as or larger than the overdischarge indicating drive pulse Pkh.

The term, “regular driving”, referred to herein is an operation to drive the stepping motor 108 to rotate once each time a predetermined time has elapsed. For example, it is an operation to rotationally drive the stepping motor 108 to advance the second hand of a timepiece by one step per second to display a time. Also, the term, “irregular driving”, referred to herein is an operation to rotationally drive the stepping motor 108 in a manner different from the regular driving. For example, it is an operation to drive the stepping motor 108 to rotate as many times as a total in a predetermined time each time the predetermined time has elapsed. For example, in a case where the regular driving is an operation to advance the second hand by one step per second, it is configured in such a manner that the second hand is advanced by two steps per two seconds by the irregular hand movement.

After the control circuit 104 performs the control so that the stepping motor 108 is rotationally driven by the irregular driving in Step S501, the control circuit 104 ends the processing while maintaining a condition under which the stepping motor 108 is driven by the overdischarge indicating drive pulse Pkh in the following driving. In a case where the control circuit 104 proceeds to Step S203 in the following driving, because it maintains the condition under which the stepping motor 108 is driven by the overdischarge indicating drive pulse Pkj from the last processing, the control circuit 104 determines that the main drive pulse P1 used in the current driving is the overdischarge indicating drive pulse Pkh in Step S203. Hence, as in the last time, the control circuit 104 performs the control so that the stepping motor 108 is rotationally driven by the irregular driving (Step S501). Thereafter, the control circuit 104 repeats the processing described above.

The control circuit 104 drives the stepping motor 108 by changing the current main drive pulse P1 to a main drive pulse P1 ranked down by a predetermined number of grades (ranked down by one grade in this embodiment) from the overdischarge indicating drive pulse Pkh at every predetermined time (80 seconds in this embodiment) (Steps S202, S207, and S204). In a case where it is possible to rotate the stepping motor 108 by the main drive pulse P1, the control circuit 104 determines that the secondary battery 111 is not in the overdischarge region and therefore ends the processing while maintaining a condition under which the stepping motor 108 is driven by the current main drive pulse P1 in the following driving (Step S205). Consequently, the irregular driving is stopped in the following driving.

As has been described, according to the fourth embodiment, upon determination of ranking up to the overdischarge indicating drive pulse Pkh having predetermined energy, the control circuit 104 determines that the secondary battery 111 is in the overdischarge region and therefore performs the control to rotationally drive the stepping motor 108 by the irregular driving different from the regular driving. It thus becomes possible to request the user to charge the secondary battery 111 without having to provide a dedicated circuit and the like to detect a voltage of the secondary battery 111.

In the respective embodiments above, it is configured in such a manner that energy ranks are changed by changing a pulse width by using a square-wave main drive pulse as the main drive pulse P1. However, a comb-shaped main drive pulse may be used so that drive energy is changed by changing a duty ratio while keeping the pulse width constant. Alternatively, drive energy may be changed by changing the number of comb teeth while keeping the duty ratio constant (in this case, the pulse width is changed) or the drive energy may be changed by changing the pulse voltage, and the like.

Also, the solar battery 112 is incorporated as the charger of the secondary battery 111. However, a charger other than the solar battery 112, such as means for charging the secondary battery 111 by automatic winding or manual winding, are also available. Further, the charger may be provided separately from the analog electronic timepiece.

Further, the embodiments described above are also applicable to a stepping motor that drives an object other than the hands of a timepiece and calendars.

Furthermore, an electronic timepiece has been described as an application of the stepping motor by way of example. However, the embodiments above are also applicable to an electronic device using a motor.

The stepping motor control circuit of the invention is applicable to various electronic devices using a stepping motor.

Also, the electronic timepiece of the invention can be applied to various analog electronic timepieces including various analog electronic timepieces with a calendar function, such as an analog electronic watch with a calendar function and an analog electronic clock with a calendar function.

What is claimed is:

1. A stepping motor control circuit, comprising:
a secondary battery as a power supply that supplies power at least to a stepping motor;
a rotation detection portion that detects a rotation state of the stepping motor; and
a control portion that drives the stepping motor by selecting a drive pulse having energy corresponding to the rotation state of the stepping motor from a plurality of drive pulses,
wherein, upon determination a voltage of the secondary battery coming out of a proper charge region, the control portion performs a predetermined operation corresponding to the voltage of the secondary battery.

2. A stepping motor control circuit according to claim 1, wherein:
upon determination that it is possible to rotate the stepping motor by an overcharge indicating drive pulse having predetermined energy, the control portion determines that the secondary battery is in an overcharge region and drives the stepping motor by changing a current drive pulse to an overconsuming drive pulse having larger energy than the overcharge indicating drive pulse.

3. A stepping motor control circuit according to claim 2, wherein:
a plurality of main drive pulses each having different energy and a correction drive pulse having larger energy than the respective main drive pulses are prepared as the plurality of drive pulses; and
the overcharge indicating drive pulse is a main drive pulse having minimum energy among the plurality of main drive pulses.

4. A stepping motor control circuit according to claim 2, wherein:
a plurality of main drive pulses each having different energy and a correction drive pulse having larger energy than the respective main drive pulses are prepared as the plurality of drive pulses; and
the overconsuming drive pulse is a main drive pulse having maximum energy among the plurality of main drive pulses.

5. A stepping motor control circuit according to claim 3, wherein:
a plurality of main drive pulses each having different energy and a correction drive pulse having larger energy than the respective main drive pulses are prepared as the plurality of drive pulses; and
the overconsuming drive pulse is a main drive pulse having maximum energy among the plurality of main drive pulses.

6. A stepping motor control circuit according to claim 2, wherein:
a plurality of main drive pulses each having different energy and a correction drive pulse having larger energy than the respective main drive pulses are prepared as the plurality of drive pulses; and
the overconsuming drive pulse is the correction drive pulse.

7. A stepping motor control circuit according to claim 3, wherein:
a plurality of main drive pulses each having different energy and a correction drive pulse having larger energy than the respective main drive pulses are prepared as the plurality of drive pulses; and
the overconsuming drive pulse is the correction drive pulse.

8. A stepping motor control circuit according to claim 2, wherein:
a plurality of main drive pulses each having different energy and a correction drive pulse having larger energy than the respective main drive pulses are prepared as the plurality of drive pulses; and
the overconsuming drive pulse is a drive pulse as a combination of the overcharge indicating drive pulse and the correction drive pulse.

9. A stepping motor control circuit according to claim 3, wherein:
a plurality of main drive pulses each having different energy and a correction drive pulse having larger energy than the respective main drive pulses are prepared as the plurality of drive pulses; and
the overconsuming drive pulse is a drive pulse as a combination of the overcharge indicating drive pulse and the correction drive pulse.

10. A stepping motor control circuit according to claim 2, wherein:
the control portion drives the stepping motor by changing the current drive pulse to the overcharge indicating drive pulse at every predetermined time and in a case where it is impossible to rotate the stepping motor by the overcharge indicating drive pulse, the control portion drives the stepping motor by changing the current drive pulse to a main drive pulse other than the overconsuming drive pulse.

11. A stepping motor control circuit according to claim 3, wherein:
the control portion drives the stepping motor by changing the current drive pulse to the overcharge indicating drive pulse at every predetermined time and in a case where it is impossible to rotate the stepping motor by the overcharge indicating drive pulse, the control portion drives the stepping motor by changing the current drive pulse to a main drive pulse other than the overconsuming drive pulse.

12. A stepping motor control circuit according to claim 4, wherein:
the control portion drives the stepping motor by changing the current drive pulse to the overcharge indicating drive pulse at every predetermined time and in a case where it is impossible to rotate the stepping motor by the overcharge indicating drive pulse, the control portion drives the stepping motor by changing the current drive pulse to a main drive pulse other than the overconsuming drive pulse.

13. A stepping motor control circuit according to claim 5, wherein:
the control portion drives the stepping motor by changing the current drive pulse to the overcharge indicating drive pulse at every predetermined time and in a case where it is impossible to rotate the stepping motor by the overcharge indicating drive pulse, the control portion drives the stepping motor by changing the current drive pulse to a main drive pulse other than the overconsuming drive pulse.

14. A stepping motor control circuit according to claim 6, wherein:
the control portion drives the stepping motor by changing the current drive pulse to the overcharge indicating drive pulse at every predetermined time and in a case where it is impossible to rotate the stepping motor by the overcharge indicating drive pulse, the control portion drives the stepping motor by changing the current drive pulse to a main drive pulse other than the overconsuming drive pulse.

15. A stepping motor control circuit according to claim 1, wherein:
upon determination of ranking up to an overdischarge indicating drive pulse having predetermined energy, the control portion determines that the secondary battery is in an overdischarge region and rotationally drives the stepping motor by irregular driving different from regular driving.

16. A stepping motor control circuit according to claim 15, wherein:
a plurality of main drive pulses each having different energy and a correction drive pulse having larger energy than the respective main drive pulses are prepared as the plurality of drive pulses; and
the overdischarge indicating drive pulse is a main drive pulse having maximum energy among the plurality of main drive pulses.

17. A stepping motor control circuit according to claim 15, wherein:
the control portion drives the stepping motor to rotate once each time a predetermined time has elapsed by the regular driving and drives the stepping motor to rotate several times each time a predetermined time has elapsed by the irregular driving.

18. A stepping motor control circuit according to claim 15, wherein:
the control portion drives the stepping motor by changing the current main drive pulse to a main drive pulse ranked down by a predetermined number of grades from the overdischarge indicating drive pulse at every predetermined time and in a case where it is possible to rotate the stepping motor by the changed main drive pulse, the control portion determines that the secondary battery is not in the overdischarge region and stops the irregular driving.

19. A stepping motor control circuit according to claim 1, further comprising:
a charger that charges the secondary battery.

20. An analog electronic timepiece, comprising:
a stepping motor that rotationally drives hands of a timepiece; and
a control portion that controls the stepping motor,
wherein the control portion that controls the stepping motor is formed of the stepping motor control circuit set forth in claim 1.
